(19) United States
(12) Patent Application Publication
(10) Pub. No.: US 2007/0288999 A1
(43) Pub. Date: Dec. 13, 2007

(54) USER AUTHENTICATION METHOD AND USER AUTHENTICATION DEVICE

(75) Inventor: Toshiki Ogawa, Musashino-shi (JP)

Correspondence Address: SUGHRUE MION, PLLC, 2100 PENNSYLVANIA AVENUE, N.W., SUITE 800, WASHINGTON, DC, 20037, US

(73) Assignee: YOKOGAWA ELECTRIC CORPORATION, Musashino-shi (JP)

(21) Appl. No.: 11/746,081

(22) Filed: May 9, 2007

(30) Foreign Application Priority Data
Jun. 13, 2006 (JP) 2006-163480

(51) Int. Cl. H04L 9/32

(52) U.S. Cl. 726/5

(57) ABSTRACT

The invention provides a user-authentication method whereby user-authentication is enabled with reference to application software having no function for user-authentication, and a history of accesses can be recorded, and a user-authentication device for carrying out the same. An authentication means executes user-authentication on the basis of pre-defined authentication information at the time of log-in against application software. A log-off recognition means monitors an application state of the application software, and recognizes completion of the application software as log-off, A recording means records the log-in, and the log-off, in association with the user of the application software. If failure in user-authentication occurs, a log-in inhibition means inhibits log-in thereafter.

### FIELD OF THE INVENTION

The invention relates to a user-authentication method for executing user-authentication on a user of application software, and a user-authentication device for carrying out the same.

### BACKGROUND OF THE INVENTION

In the case of a user making use of application software mounted in a computer, the user first logs in the computer before activating the application software. With a system wherein careful consideration is given to a security aspect, user-authentication may be executed in multiple stages at times. In such cases, the user logs in the computer, and subsequently, user-authentication conforming to workings unique to application software is executed.

In JP 2006-65712 A, there is disclosed an integrated user-authentication method for integrally executing authentication on a user making use of plural units of application software

### SUMMARY OF THE INVENTION

In this case, user-authentication is executed on the basis of application software-by-application software, and results of authentication can be recorded in the form of a log, which can be utilized for analysis of causes and so forth in case that a security trouble occurs.

However, when application software having no function for user-authentication, such as application software without an authentication interface, and so forth, is incorporated in a system, it is not possible to implement user-authentication on the basis of application software-by-application software, so that there is a possibility of allowing an improper user to make use of application software. Further, it is not possible to recognize a user on the basis of application software-by-application software, and to leave a history of accesses made to application software on record.

It is therefore an object of the invention to provide a user-authentication method whereby user-authentication is enabled with reference to application software having no function for user-authentication, and a history of accesses can be recorded, and a user-authentication device for carrying out the same.

In a first aspect of the invention, there is provided a user-authentication method for executing user-authentication on a user of application software, said method comprising a first step for executing user-authentication on the basis of pre-defined authentication information at the time of log-in against application software, a second step for monitoring an application state of the application software, and recognizing completion of the application software as log-off, a third step for recording the log-in, and the log-off, in association with the user of the application software, wherein the first step, the second step, and the third step are executed according to a program independent from the application software.

In the first step, the authentication information may be collated with information inputted by the user.

There may be provided a step whereby if failure in user-authentication occurs in the first step, log-in thereafter is inhibited.

In a second aspect of the invention, there is provided a user-authentication device for executing user-authentication on a user of application software, said device comprising an authentication means for executing user-authentication on the basis of pre-defined authentication information at the time of log-in against application software, a log-off recognition means for monitoring an application state of the application software, and recognizing completion of the application software as log-off, and a recording means for recording the log-in, and the log-off, in association with the user of the application software, wherein the authentication means, the log-off recognition means, and the recording means are made up by a computer that functions according to a program independent from the application software.

The authentication means may collate authentication information with information inputted by the user.

The user-authentication device may further comprise a log-in inhibition means wherein if failure in user-authentication occurs, log-in thereafter is inhibited.

With the user-authentication method according to the invention, while the user-authentication is executed on the basis of the pre-defined authentication information at the time of log-in against application software, the application state of the application software is monitored, and the completion of the application software is recognized as log-off, thereby recording the log-in, and the log-off, in association with the user of the application software, so that user-authentication is enabled with reference to the application software having no function for the user-authentication, and a history of accesses can be recorded.

### BRIEF DESCRIPTION OF THE DRAWINGS

FIG. 1 is a block diagram showing a makeup of an embodiment of a user-authentication device according to the invention;

FIG. 2 is a flow chart showing a procedure of operation for log-in and log-off, in connection with application software; and

FIG. 3 is a flow chart showing a procedure of operation for timer interruption processing at a fixed cycle.

### PREFERRED EMBODIMENTS OF THE INVENTION

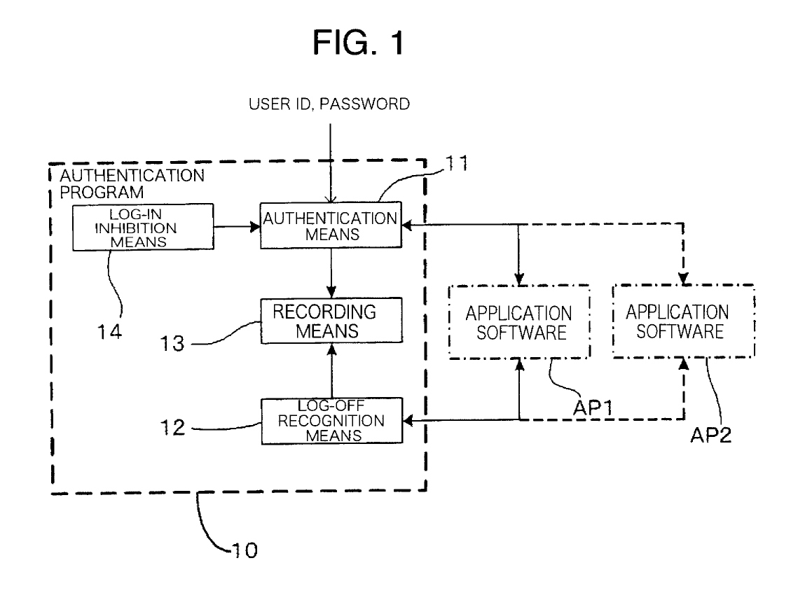

An embodiment of a user-authentication device according to the invention is described hereinafter with reference to FIGS. 1 to 3.

As shown in FIG. 1, the user-authentication device according to the present embodiment of the invention comprises an authentication means 11 for executing user-authentication on the basis of pre-defined authentication information at the time of log-in against application software, a log-off recognition means 12 for monitoring an application state of the application software, and recognizing completion of the application software as log-off, a recording means 13 for recording the log-in, and the log-off, in association with a user of application software, and a log-in inhibition means 14 wherein if failure in user-authentication occurs a predetermined number of times in succession, log-in thereafter is inhibited. The authentication means 11, the log-off recognition means 12, the recording means 13, and the log-in inhibition means 14 are made up by a computer that functions according to an authentication program 10 mounted therein, independent from the application software.

A log file showing the authentication information for use in authentication, and accesses to application software is stored in the computer. Further, the computer controls log-in inhibition information for controlling log-in against application software.

Now, operation by the user-authentication device according to the present embodiment is described hereinafter.

A user activates the authentication program 10 instead of activating application software, and specifies application software as desired. The authentication program 10 after activated makes a request to the user for authentication manipulation.

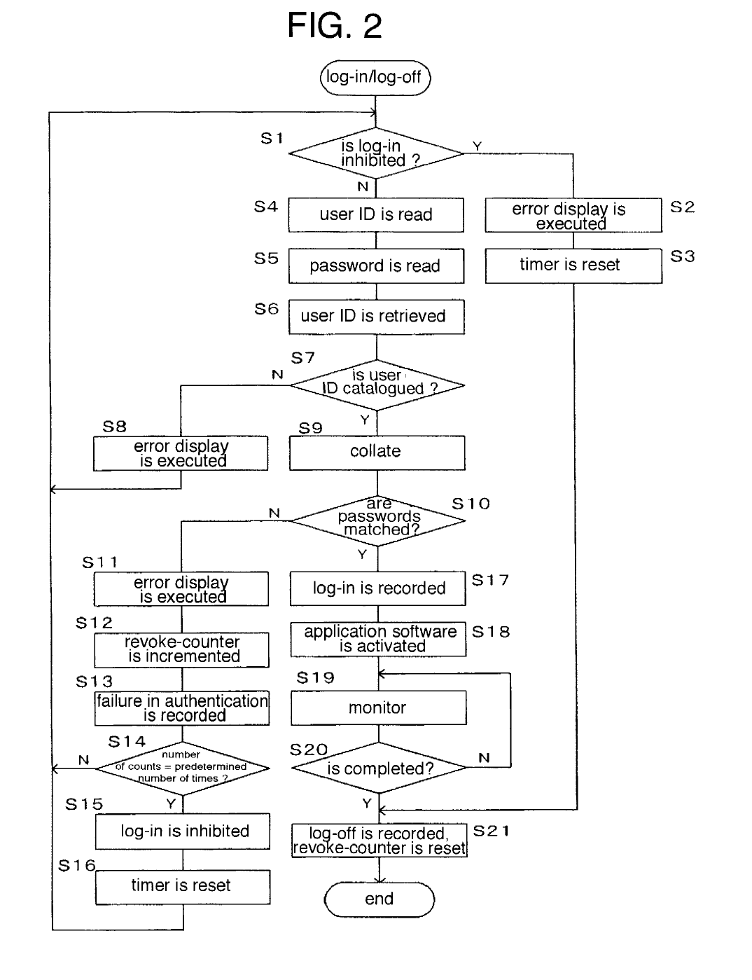

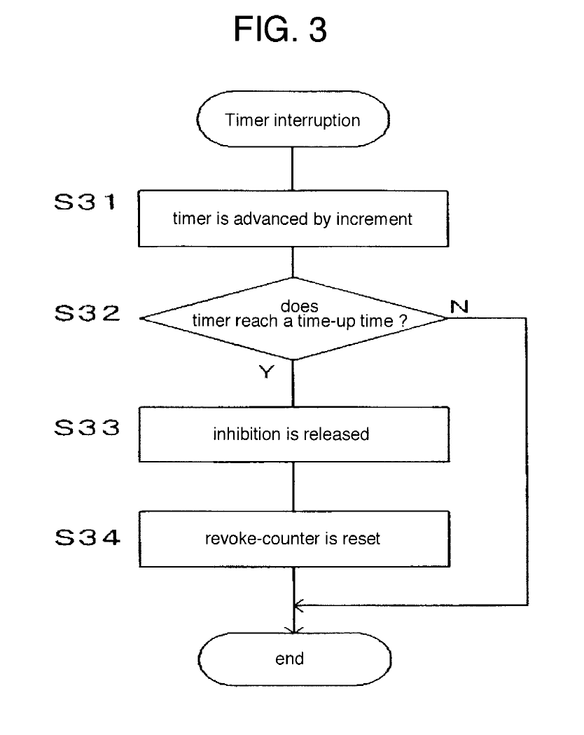

FIGS. 2, and 3 each are a flow chart showing a procedure of the operation by the user-authentication device according to the present embodiment.

In FIG. 2, steps S1 to S21 show the procedure of the operation for log-in and log-off, in connection with application software.

In the step S1 of FIG. 2, the operation determines on the basis of the log-in inhibition information whether or not log-in by a user corresponding to relevant application software is inhibited, and if determination is affirmative, the operation proceeds to the step S2 while proceeding to the step S4 if determination is negative. As described later in this description, if a password inputted by a user is incorrect a predetermined number of times in succession, lob-in is inhibited.

In the step S2, the operation executes error display to the effect that log-in is inhibited, and reset a timer in the step S3 before reverting to the step S1. As described later in this description, the timer is for controlling log-in inhibition/log-in release.

Meanwhile, in the step S4, the operation reads a user ID inputted through manipulation by the user.

Next, in the step S5, the operation reads the password inputted through manipulation by the user.

Next, in the step S6, the operation makes access to the authentication information to determine whether or not the user ID as inputted has been cataloged. User IDs in association with passwords, respectively, have been cataloged in the authentication information. If determination in the step S7 is affirmative, the operation proceeds to the step S9 while proceeding to the step S8 if the determination is negative.

In the step S8, the operation executes error display to the effect that the user ID is not cataloged, thereby reverting to the step S1.

Meanwhile, in the step S9, the operation makes access to the authentication information to collate a password associated with the user ID as inputted with the password inputted. In the case of matching between those passwords as a result of collation, the operation proceeds to the step S 17 while proceeding to the step S11 in the case of mismatching.

In the step S11, the operation executes error display to the effect that the password is incorrect.

Next, in the step S12, the number of counts by a revoke-counter is increased by one increment. The number of counts by the revoke-counter indicates the number of times that an incorrect password is inputted in succession.

Then, in the step S13, the operation keeps a record to the effect that it has failed in authentication. The content of the record includes the user ID and time.

Next, in step S14, the operation determines whether or not the number of counts by the revoke-counter has reached the predetermined number of times, and if determination is affirmative, the operation proceeds to the step S15 while reverting to the step S1 if determination is negative. Herein, the predetermined number of times refers to the number of times that the incorrect password is inputted in succession, which is set as a condition for inhibiting log-in.

Next, in step S16, the operation resets the timer, and reverts to the step S1. As described later in this description, the timer has a function of controlling time from the log-in inhibition until the log-in release. With the elapse of predetermined time, the log-in inhibition is released.

Meanwhile, in the step S17, the log-in against the application software is recorded on the log file. The content of the record includes the user ID and time.

Next, in the step S18, the operation activates the relevant application software.

Then, in the step S19, the operation monitors an execution state of the application software. Next, in the step S20, the operation determines whether or not the execution of the application software has been completed, and if determination is affirmative, the operation proceeds to the step S21 while continuing monitoring in the step S19 if determination is negative.

In the step S21, the operation resets the revoke-counter while keeping a record of the log-off from the relevant application software in the log file, thereby completing processing. The content of the record includes the user ID and time.

In FIG. 3, steps S31 to S34 show a procedure of operation for timer interruption processing at a fixed cycle.

In the step S31 of FIG. 3, the operation advances the timer by an increment for predetermined time only. By so doing, the timer is advanced by the increment at a fixed rate.

Next, in the step S32, the operation determines whether or not the timer has reached a time-up time. The time-up time is pre-set to correspond to the time from the log-in inhibition until the log-in release (the predetermined time as above).

If determination in the step S32 is affirmative, the operation proceeds to the step S33, and if the determination is negative, processing is completed.

In the step S33, the operation releases inhibition of the log-in by the user corresponding to the relevant application software.

Next, in the step S34, the operation resets the revoke-counter, thereby completing processing.

The steps for user-authentication (the steps from S4 to S10) correspond to the function of the authentication means 11, the steps for monitoring the application state of the application software (the steps from S19 to S20) correspond to the function of the log-off recognition means 12, the steps for recording the log-in, and the log-off, in association with the user (the steps S17, S21, and so forth), correspond to the function of the recording means 13, and the steps for inhibit the log-in (the steps S1 to S3, S14 to S16, S31 to S34 and so forth) correspond to the function of the log-in inhibition means 14, respectively.

As described in the foregoing, with the user-authentication device according to the present embodiment of the invention, even in the case where a system makes use of the application software having no function for the user-authentication, the user-authentication can be executed according to the authentication program 10. Accordingly, it is possible to effectively prevent an ill-intentioned user from making improper use of application software. Further, since recording on the log file is executed according to the authentication program 10, it becomes possible to leave the history of accesses made to the application software on record. Thus, thanks to the authentication program 10, it becomes possible to provide a function for protecting, for example, application software without an authentication interface.

Further, the authentication program may have a function for single sign on.

In the case where two units of application software AP1, AP2 are mounted, for example, as shown in FIG. 1, log-in against the two units of the application software AP1, AP2 may be authorized if a user specifies the two units of the application software AP1, AP2 to thereby execute authentication operation (inputting of a user ID and a password).

Furthermore, the user-authentication device according to the present embodiment can also be made up such that if the authentication operation is accepted, and log-in against the application software AP1 is authorized, log-on against the application software AP2 is automatically implemented.

It is to be pointed out that the invention is not limited in scope to the embodiment described hereinbefore, and that the invention is widely applicable to a user-authentication method for executing user-authentication on a user of application software, and a user-authentication device for carrying out the same.

What is claimed is:

1. A user-authentication method for executing user-authentication on a user of application software, said method comprising:
a first step for executing user-authentication on the basis of pre-defined authentication information at the time of log-in against application software;
a second step for monitoring an application state of the application software, and recognizing completion of the application software as log-off, and
a third step for recording the log-in, and the log-off, in association with the user of the application software;
wherein the first step, the second step, and the third step are executed according to a program independent from the application software.

2. The user-authentication method according to claim 1, wherein the authentication information is collated with information inputted by the user in the first step.

3. The user-authentication method according to claim 1 or 2, further comprising a step whereby if failure in user-authentication occurs in the first step, log-in thereafter is inhibited.

4. A user-authentication device for executing user-authentication on a user of application software, said device comprising:
an authentication means for executing user-authentication on the basis of pre-defined authentication information at the time of log-in against application software;
a log-off recognition means for monitoring an application state of the application software, and recognizing completion of the application software as log-off; and
a recording means for recording the log-in, and the log-off, in association with the user of the application software;
wherein the authentication means, the log-off recognition means, and the recording means are made up by a computer that functions according to a program independent from the application software.

5. The user-authentication device according to claim 4, wherein the authentication means collates authentication information with information inputted by the user.

6. The user-authentication device according to claim 4 or 5, further comprising a log-in inhibition means wherein if failure in user-authentication occurs, log-in thereafter is inhibited.
